(19) United States
(12) Patent Application Publication
(10) Pub. No.: US 2014/0326181 A1
(43) Pub. Date: Nov. 6, 2014

(54) DEPOSITION APPARATUS

(71) Applicant: Samsung Display Co., Ltd., Yongin-City (KR)

(72) Inventor: Sang-Hoon Kim, Yongin-City (KR)

(21) Appl. No.: 14/055,137

(22) Filed: Oct. 16, 2013

(30) Foreign Application Priority Data
May 2, 2013 (KR) 10-2013-0049604

(51) Int. Cl. B05B 15/04

(52) U.S. Cl. CPC B05B 15/0425
USPC 118/715; 118/326

(57) ABSTRACT

A deposition apparatus includes: a chamber; a stage disposed in the chamber and equipped with a substrate; a nozzle unit disposed to face the substrate and configured to spray a deposition material toward the substrate; and a collector unit surrounding the nozzle unit and configured to collect a residual deposition material not deposited on the substrate. The collector unit includes a collection surface for collecting the residual deposition material and a collection pipe for transferring the collected residual deposition material outside the chamber. Thus, a loss of the deposition material may be minimized during a deposition process.

### CLAIM OF PRIORITY

This application makes reference to, incorporates the same herein, and claims all benefits accruing under 35 U.S.C. §119 from an application earlier filed in the Korean Intellectual Property Office on 2 May 2013 and there duly assigned Serial No. 10-2013-0049604.

### BACKGROUND OF THE INVENTION

1. Field of the Invention

An embodiment of the present invention relates to a deposition apparatus, and more particularly, to a deposition apparatus capable of minimizing loss of deposition material.

2. Description of the Related Art

Recently, a display device tends to be replaced with a thin and flat portable display device. An organic light emitting display device among a variety of flat display devices is a self-emitting type display device and attracts attention as a next generation display device in view of wider viewing angle, better contrast, and faster response time.

The organic light emitting display device includes an intermediate layer, a first electrode, and a second electrode. The intermediate layer includes an organic light emitting layer, from which visible light emits when a voltage is applied to the first electrode and the second electrode.

The organic light emitting layer is formed by depositing an electroluminescence (EL) deposition material on a substrate inside a vacuum chamber. More particularly, the organic emitting layer is formed by vaporizing EL deposition gas from an EL deposition material source and then depositing the EL deposition gas on a substrate.

However, most of the EL deposition material is stacked at the bottom of the chamber, and some is sucked into a vacuum pump for keeping the chamber under vacuum. The EL deposition material stacked at the bottom of the chamber is discarded during cleaning of the chamber and the deposition material sucked into the vacuum chamber is also discarded. Thus, the deposition material may be consumed more than what is needed.

The above information disclosed in this Background section is only for enhancement of understanding of the background of the described technology and therefore it may contain information that does not form the prior art that is already known in this country to a person of ordinary skill in the art.

### SUMMARY OF THE INVENTION

An embodiment of the present invention provides a deposition apparatus capable of minimizing a loss of a deposition material.

According to an aspect of the present invention, there is provided a deposition apparatus including: a chamber; a stage disposed in the chamber and equipped with a substrate; a nozzle unit disposed to face the substrate and configured to spray deposition material toward the substrate; and a collector unit surrounding the nozzle unit and configured to collect residual deposition material not deposited on the substrate. The collector unit includes a collection surface for collecting the residual deposition material and a collection pipe for transferring the collected residual deposition material outside the chamber.

The collection surface may have a horizontal cross-sectional area increasing progressively as it goes closer to the substrate from the collection pipe.

The collection surface may have a concave shape at its center or a taper shape toward its center.

The nozzle unit may include a nozzle for spraying the deposition material and a nozzle pipe for supplying the deposition material to the nozzle.

The nozzle may be positioned between a top end and a bottom end of the collection surface.

The nozzle pipe may be positioned inside the collection pipe.

The deposition apparatus may further include a vaporizer disposed outside the chamber, connected with the nozzle pipe, and configured to supply the deposition material.

The deposition apparatus may further include a storage tank disposed outside the chamber, connected with the collection pipe, and configured to store the collected residual deposition material and resupply the stored residual deposition material to the vaporizer.

The deposition apparatus may further include a second chamber that accommodates a second substrate; and a second vaporizer that is connected to a second nozzle unit for spraying the deposition material toward the second substrate. The second vaporizer is disposed outside the second chamber, and the storage tank supplies the residual deposition material to the second vaporizer.

The deposition apparatus may further include a second collector unit that is configured to collect residual deposition material not deposited on the second substrate. The residual deposition material collected by the second collector unit is stored in the storage tank.

According to another aspect of the present invention, there is provided a deposition apparatus including: at least two deposition units and one storage tank that is connected with the at least two deposition units, in which each of the at least two deposition units includes a chamber; a stage disposed in the chamber and equipped with a substrate; a nozzle unit disposed to face the substrate and configured to spray deposition material toward the substrate; and a collector unit surrounding the nozzle unit and configured to collect a residual deposition material not deposited on the substrate, in which the collector unit includes a collection surface for collecting the residual deposition material and a collection pipe for transferring the collected residual deposition material to the storage tank.

Each of the at least two deposition units may include a vaporizer disposed outside the chamber and configured to supply the deposition material to the nozzle unit.

The storage tank may supply the residual deposition material to the vaporizer included in each of the at least two deposition units.

The nozzle unit may include a nozzle pipe connected with the vaporizer at one end and a nozzle formed at the other end of the nozzle pipe and configured to spray the deposition material.

The nozzle pipe may be positioned inside the collection pipe.

The nozzle pipe may have a shutter formed therein.

The collection surface may have a horizontal cross-sectional area increasing progressively as it goes closer to the substrate from the collection pipe.

The collection surface may have a concave shape at its center or a taper shape toward its center.

The collection surface, the outer surface of the nozzle pipe, and the inner surface of the collection pipe may be processed to be hydrophobic or hydrophilic.

Each of the at least two deposition units may further include a driver connected with the stage to move the stage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating a deposition apparatus according to an embodiment of the present invention;

FIG. 2 is a view of a modification of the deposition apparatus of FIG. 1;

FIG. 3 is a view of another modification of the deposition apparatus of FIG. 1; and

FIG. 4 is an enlarged view illustrating portion “P” of FIG. 3.

### DETAILED DESCRIPTION OF THE INVENTION

Since the present invention may have diverse modified embodiments, preferred embodiments are illustrated in the drawings and are described in the detailed description of the invention. However, it should be understood that the particular embodiments are not intended to limit the present disclosure to specific forms, but rather the present disclosure is meant to cover all modification, similarities, and alternatives which are included in the spirit and scope of the present disclosure. Moreover, detailed descriptions related to well-known functions or configurations will be ruled out in order not to unnecessarily obscure subject matters of the present invention.

Relational terms such as first, second, and the like may be used for describing various elements, but the elements should not be limited by the terms. These terms are only used to distinguish one element from another.

In the following description, the technical terms are used only for explaining a specific exemplary embodiment while not limiting the present disclosure. The terms of a singular form may include plural forms unless referred to the contrary. The meaning of “comprise,” “include,” or “have” specifies the presence of stated features, integers, steps, operations, elements, components, and/or groups thereof, but does not preclude the presence or addition of one or more other features, integers, steps, operations, elements, components, and/or groups thereof.

Hereinafter, embodiments of the present invention will be described in detail with reference to the accompanying drawings.

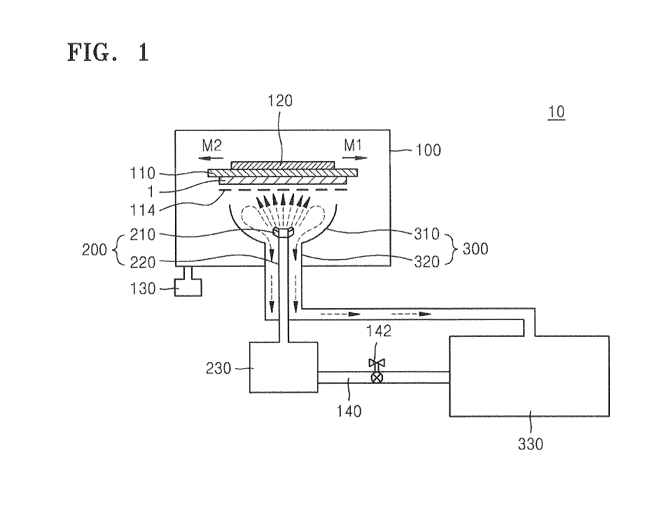

FIG. 1 is a schematic view illustrating a deposition apparatus according to an embodiment of the present invention.

In reference to FIG. 1, a deposition apparatus 10 according to an embodiment of the present invention includes a chamber 100, a stage 110 disposed in the chamber 100 and equipped with a substrate 1, a nozzle unit 200 disposed to face the substrate 1 and configured to spray a deposition material toward the substrate 1, a collector unit 300 disposed to surround the nozzle unit 200 and configured to collect residual deposition material not deposited on the substrate 1.

Also, the deposition apparatus 10 further includes a vaporizer disposed outside the chamber 100 and configured to supply the deposition material and a storage tank disposed outside the chamber 100 and configured to store the residual deposition material collected by the collector unit 300.

The chamber provides a space for performing the deposition process, and has one or more entrances (not shown) for moving the substrate 1 from the outside to the chamber 100 or from the chamber 100 to the outside. Also, a vacuum pump 130 may be connected to the chamber 100 in order to keep the interior of the chamber 100 in a desired pressure state.

The stage 110 is disposed in the chamber 100. The substrate 1 may be disposed on the substrate 1, and then a fixing unit (not shown) may be used to fix the substrate 1.

The fixing unit (not shown) may include a clamp, a pressure unit, an adhesive material, etc. Also, a deposition mask 114 having an opening, which is used for patterning during deposition, formed therein may be disposed at one side of the substrate 1.

A driver unit 120 is connected with the stage 110 to move the stage 110 in a first direction (arrow M1 direction) or a second direction (arrow M2 direction) which is the opposite of the first direction. The substrate 1 on the stage 110 is moved by moving the stage 110. Thus, the nozzle unit 200 may spray the deposition material on the entire one side of the substrate 1.

The nozzle unit 200 sprays the deposition material toward the substrate 1. Particularly, the nozzle unit 200 includes a nozzle 210 and a nozzle pipe for supplying the deposition material to the nozzle 210.

The nozzle 210 may include a nozzle hole (not shown) for spraying a vaporized deposition material and a guide unit (not shown) formed to surround the nozzle hole (not shown) and configured to control a spray angle of the deposition material.

The nozzle hole (not shown) may be formed to have a diameter less than the nozzle pipe 220 in order to increase spray velocity, and the guide unit (not shown) is formed radially with respect to the nozzle hole (not shown) and formed to have a horizontal cross-sectional area increasing progressively closer to the substrate 1, but they are not limited thereto.

For example, the nozzle hole (not shown) may be formed to extend along a direction of one side of the substrate 1, and the guide unit (not shown) may be also formed to extend along the direction of one side of the substrate 1 because the guide unit is formed to surround the nozzle hole (not shown).

The vaporizer 230 is connected to one side of the nozzle pipe 220. The vaporizer 230 is located outside the chamber 100.

The vaporizer 230 may be a deposition source having a crucible (not shown) for receiving the deposition material and a heating unit, such as a heater, (not shown) around the crucible (not shown) to heat the crucible. Alternatively, although not shown, the vaporizer 230 is supplied with a liquid deposition material from an exterior material supplier to vaporize the liquid deposition material.

In this way, the deposition material vaporized by the vaporizer 230 is spayed toward the substrate 1, by way of the nozzle pipe 220 connected with vaporizer 230 at the one end, through the nozzle 210 formed at the other end of the nozzle pipe 220. Some of the deposition material sprayed toward the substrate 1 sinks to the lower portion of the chamber 100 due to the force of gravity.

The collector unit 300 collects residual deposition material not deposited on the substrate but sunk to the lower portion of the chamber 100. The collector unit 300 surrounds the nozzle unit 200 and includes a collection surface 310 for collecting the residual deposition material and a collection pipe 320 for transmitting the collected deposition material outside the chamber 100.

The collection surface 310 may be formed to have a horizontal cross-sectional area increasing progressively closer to the substrate 1 from the collection pipe 320. For example, the collection surface 310 may be concave at the center. Accordingly, the collection surface 310 may effectively collect the residual deposition material to gather the residual deposition material at one place.

The collector pipe 320 is connected with the storage tank 330 outside the chamber 100 and configured to carry the residual deposition material collected by the collection surface to the storage tank 330. Also, although not shown, a suction force caused by a motor (not shown) for effective collection may act in the collection pipe 320.

Meanwhile, the collector unit 300 is formed to surround the nozzle unit 200 in order to effectively collect the residual deposition material not deposited on the substrate 1, and thus the collection pipe 320 may be also formed to partially surround the nozzle pipe 220. That is, the nozzle pipe 220 is positioned inside the collection pipe 320, and in an area where the nozzle pipe 220 and the collection pipe 230 overlap with each other, the collected residual deposition material moves to the storage tank 330 through a space between the nozzle pipe 220 and the collection pipe 320.

Furthermore, the nozzle 210 may be disposed between a top end and a bottom end of the collection surface 310 in order to effectively collect the residual deposition material that is not deposited on the substrate 1.

For example, the residual deposition material may increasingly go over the top of the collection surface 310 if a position of the nozzle 210 is too high, and the residual deposition material may directly flow into the collection pipe 320 due to a suction force in the collection pipe 320 if the position of the nozzle 210 is too low. Thus, a relative position between the nozzle 210 and the collection surface 310 may be determined in consideration of a spray pressure of the deposition pressure, a suction force in the collection pipe 320, etc.

Returning to FIG. 1, the storage tank 330 and vaporizer 230 is connected with each other through a delivery pipe 140. Accordingly, the residual deposition material stored in the storage tank 330 may be resupplied to the vaporizer 230.

Meanwhile, the delivery pipe 140 may have a valve 142 for controlling the amount of residual deposition material resupplied and a pump (not shown) for preventing the deposition material from moving from the vaporizer 230 to the storage tank 330.

According to the present invention, the residual deposition material that is not deposited on the substrate 1 can be efficiently collected and resupplied, thereby minimizing a loss of the deposition material caused during the deposition.

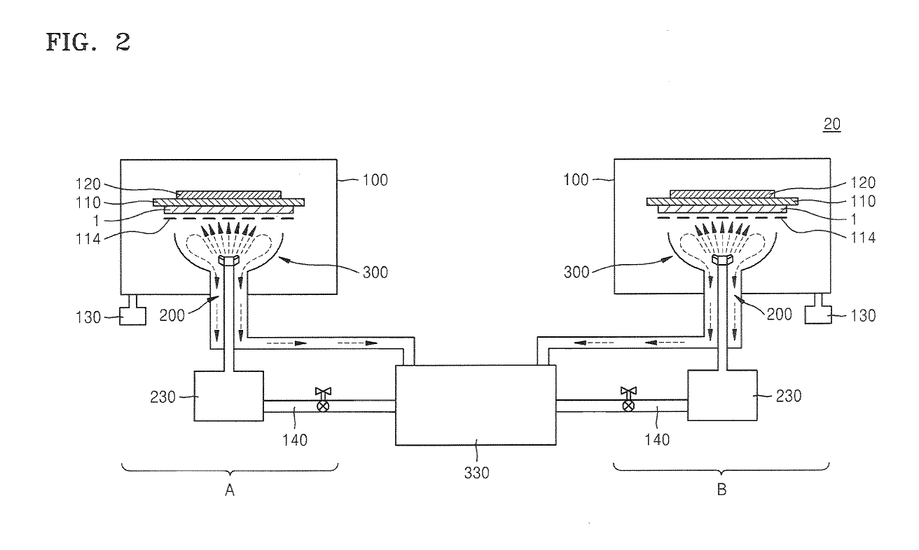

FIG. 2 is a view of a modification of the deposition apparatus of FIG. 1.

The deposition apparatus 20 of FIG. 2 includes a first deposition unit A, a second deposition unit B, and a storage tank 330 connected to the first deposition unit A and the second deposition unit B.

Each of the first deposition unit A and the second deposition unit B includes a chamber 100, a stage 110 disposed in the chamber 100 and provided with substrate 1, a nozzle unit 200 disposed to face the substrate 1 and configured to spray a deposition material to the substrate 1, a collector unit 300 disposed to surround the nozzle unit 200 and configured to collect residual deposition material not deposited on the substrate 1. The chamber 100, the nozzle unit 200, and the collector unit 300 are the same as described with reference to FIG. 1, and thus will be described in detail.

Also, a vacuum pump 130 may be connected to the chamber 100 in order to keep the interior of the chamber 100 in a desired pressure state, and the stage 110 equipped with the substrate 1 may be disposed. Furthermore, a driver 120 for moving the stage 110 may be disposed, and a deposition mask 114 having an opening for patterning during deposition formed therein may be disposed at one side of the substrate 1.

The nozzle unit 200 sprays deposition material toward the substrate 1 and receives the deposition material from vaporizer 230 disposed outside the chamber 100.

The collector unit 300 collects a residual deposition material not deposited on the substrate 1 and transfers the residual deposition material to the storage tank disposed outside the chamber 100. That is, the residual deposition material collected by the first deposition unit A and the second deposition unit B is stored in the storage tank 330. Also, the storage tank 330 may be connected to a vaporizer 230, which is included in each of two deposition units A and B, through two delivery pipe 140 to resupply the stored deposition material. Accordingly, a loss of the deposition material may be minimized during a deposition process.

Also, when the storage tank 330 resupplies the deposition material to the vaporizer 230, which is included in each of two deposition units A and B, the storage tank 330 may preferentially supply the deposition material to any one of the vaporizer 230 of the deposition unit A and the vaporizer 230 of the deposition unit B.

For example, when the amount of deposition material contained in the vaporizer 230 of the first deposition unit A is less than the amount of deposition material contained in the vaporizer 230 of the first deposition unit B, the storage tank 330 may preferentially resupply the deposition material to the vaporizer 230 of the deposition unit A. Thus, process speeds of the first and second deposition units A and B can be kept the same, thereby enhancing the entire yield.

Meanwhile, two deposition units A and B are described in FIG. 2, but the present invention is not limited thereto. That is, three or more deposition units may be formed. However, though the three or more deposition units are formed, the residual deposition material collected by the deposition units may be stored in one storage tank, and the storage tank may resupply the stored deposition material to the deposition unit.

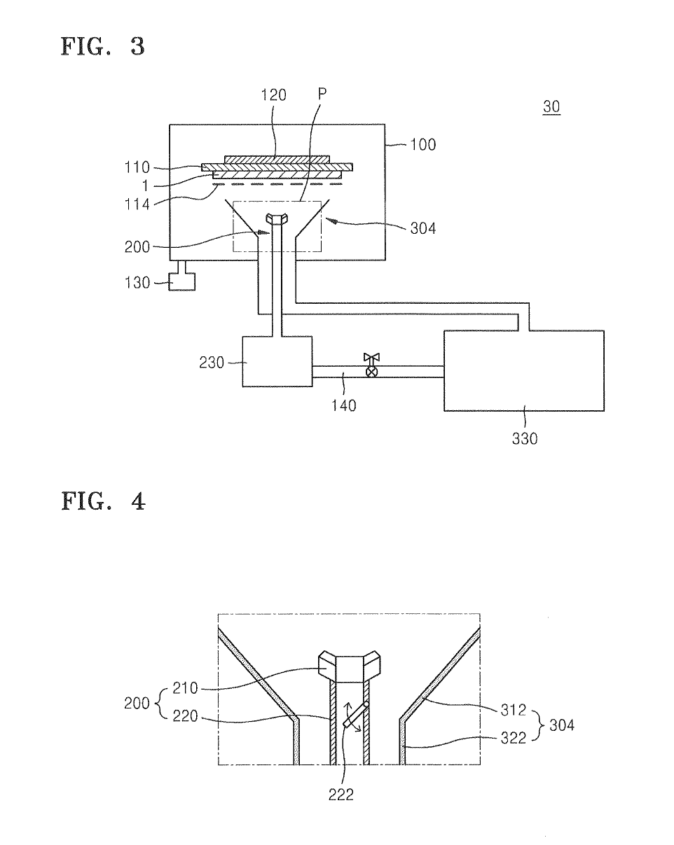

FIG. 3 is a view of another modification of the deposition apparatus of FIG. 1, and FIG. 4 is an enlarged view illustrating a portion “P” of FIG. 3.

In reference to FIGS. 3 and 4, the deposition apparatus 30 includes a chamber 100, a stage 110 disposed in the chamber 100 and equipped with the substrate 1, a nozzle unit 200 disposed to face the substrate 1 and configured to spray a deposition material to the substrate 1, a collector unit 304 disposed to surround the nozzle unit 200 and configured to collect residual deposition material not deposited on the substrate 1.

The stage 110 is equipped with the substrate 1, and the driver 120 moves the stage 110. Also, a deposition mask 114 having an opening, which is used for patterning during deposition, formed therein may be disposed at one side of the substrate 1, and a vacuum pump 130 may be connected to the chamber 100 in order to keep the interior of the chamber 100 in a desired pressure state.

The nozzle unit 200 includes a nozzle 210 for spraying the deposition material toward the substrate 1 and a nozzle pipe 220 for supplying the deposition material to the nozzle 210. The nozzle pipe 220 is connected with the vaporizer 230 located outside the chamber 100.

Also, a shutter 222 may be formed in the nozzle pipe 220. The shutter 222, for example, may be combined with an inner surface of the nozzle pipe 220 such that one end of the shutter 222 may be rotated, but is limited thereto, may have a variety of configurations.

The shutter 222 can control the amount of deposition material passing through the nozzle pipe 220 or prevent the deposition material from being sprayed into the chamber 100 with the deposition process being not performed, for example with the substrate 1 being transferred into the chamber 100. Accordingly, a loss of the deposition material may be further reduced.

The collector unit 304 includes a collection surface 312 for collecting the residual deposition material and a collection pipe 322 for transmitting the collected deposition material outside the chamber 100. The collection pipe 322 is connected with the storage tank 330 outside the chamber 100 and the residual deposition material collected by the collector unit 304 is stored in the storage tank 330.

Meanwhile, the collector unit 304 is formed to surround the nozzle unit 200 in order to effectively collect the residual deposition material.

In particular, the collection surface 312 may be formed to have a horizontal cross-sectional area increasing progressively closer to the substrate 1 from the collection pipe 322. For example, the collection surface 312 may have a taper shape with a certain slope, as shown in figures. Furthermore, the collection pipe 322 is formed to surround the nozzle pipe 220.

That is, the residual deposition material falling to the lower portion of the chamber 100 due to the force of gravity is collected by the collection surface 312 and moved to the storage tank 330 through a space between the nozzle pipe 220 and the collection pipe 322.

Accordingly, the collection surface 312, the outer surface of the nozzle pipe 220, and the inner surface of the collection pipe 322, with which the residual deposition material comes in direct contact, are processed to be hydrophobic or hydrophilic depending on a characteristic of the deposition material. Also, the nozzle pipe 220 and the collection pipe 322 may be kept above a certain temperature, thereby effectively preventing the residual deposition material collected in a vaporized state from being deposited while being moved to the storage tank 330.

Meanwhile, the storage tank 330 can be connected with the vaporizer 230 through the delivery pipe 140, and the deposition material stored in the storage tank 330 can be resupplied to the vaporizer 230, thereby minimizing the loss of the deposition material caused during the deposition process.

It will be appreciated that for simplicity and clarity of illustration, elements shown in the figures have not necessarily been drawn to scale.

While the present invention has been particularly shown and described with reference to exemplary embodiments thereof, it will be understood by those of ordinary skill in the art that various changes in form and details may be made therein without departing from the spirit and scope of the present invention as defined by the following claims. Accordingly, the technical scope of the present invention should be determined only by the technical concept of the appended claims.

What is claimed is:

1. A deposition apparatus comprising:
a chamber;
a stage disposed in the chamber and equipped with a substrate;
a nozzle unit disposed to face the substrate and configured to spray a deposition material toward the substrate; and
a collector unit surrounding the nozzle unit and configured to collect a residual deposition material not deposited on the substrate, the collector unit comprising a collection surface collecting the residual deposition material and a collection pipe transferring the collected residual deposition material outside the chamber.

2. The deposition apparatus according to claim 1, wherein the collection surface has a horizontal cross-sectional area increasing progressively as it goes closer to the substrate from the collection pipe.

3. The deposition apparatus according to claim 2, wherein the collection surface has a concave shape at its center or a taper shape toward its center.

4. The deposition apparatus according to claim 1, wherein the nozzle unit comprises a nozzle for spraying the deposition material and a nozzle pipe for supplying the deposition material to the nozzle.

5. The deposition apparatus according to claim 4, wherein the nozzle is positioned between a top end and a bottom end of the collection surface.

6. The deposition apparatus according to claim 4, wherein the nozzle pipe is positioned inside the collection pipe.

7. The deposition apparatus according to claim 4, further comprising a vaporizer disposed outside the chamber, connected with the nozzle pipe, and configured to supply the deposition material.

8. The deposition apparatus according to claim 7, further comprising a storage tank disposed outside the chamber, connected with the collection pipe, configured to store the collected residual deposition material,
wherein the residual deposition material stored in the storage tank is resupplied to the vaporizer.

9. The deposition apparatus according to claim 8, further comprising a second chamber that accommodates a second substrate; and a second vaporizer that is connected to a second nozzle unit for spraying the deposition material toward the second substrate,
wherein the second vaporizer is disposed outside the second chamber and the storage tank supplies the residual deposition material to the second vaporizer.

10. The deposition apparatus according to claim 9, further comprising a second collector unit that is configured to collect a residual deposition material not deposited on the second substrate,
wherein the residual deposition material collected by the second collector unit is stored in the storage tank.

11. A deposition apparatus comprising:
at least two deposition units; and
one storage tank that is connected with the at least two deposition units,
wherein each of the at least two deposition units comprises,
a chamber,
a stage disposed in the chamber and equipped with a substrate,
a nozzle unit disposed to face the substrate and configured to spray deposition material toward the substrate; and
a collector unit that surrounding the nozzle unit and configured to collect a residual deposition material not deposited on the substrate, the collector unit comprising a collection surface collecting the residual deposition material and a collection pipe transferring the collected residual deposition material to the storage tank.

12. The deposition apparatus according to claim 11, wherein each of the at least two deposition units comprises a vaporizer disposed outside the chamber and configured to supply the deposition material to the nozzle unit.

13. The deposition apparatus according to claim 12, wherein the storage tank supplies the residual deposition material to the vaporizer included in each of the at least two deposition units.

14. The deposition apparatus according to claim 12, wherein the nozzle unit comprises a nozzle pipe whose one end is connected with the vaporizer and a nozzle formed at the other end of the nozzle pipe and configured to spray the deposition material.

15. The deposition apparatus according to claim 14, wherein the nozzle pipe is positioned inside the collection pipe.

16. The deposition apparatus according to claim 14, wherein the collection surface, an outer surface of the nozzle pipe, and an inner surface of the collection pipe are processed to be hydrophobic or hydrophilic.

17. The deposition apparatus according to claim 14, wherein a shutter is formed in the nozzle pipe.

18. The deposition apparatus according to claim 17, wherein the collection surface has a concave shape at its center or a taper shape toward its center.

19. The deposition apparatus according to claim 11, wherein the collection surface has a horizontal cross-sectional area increasing progressively as it goes closer to the substrate from the collection pipe.

20. The deposition apparatus according to claim 11, wherein each of the at least two deposition units further comprises a driver connected with the stage to move the stage.
